(19) United States
(12) Patent Application Publication
(10) Pub. No.: US 2026/0075115 A1
(43) Pub. Date: Mar. 12, 2026

(54) REAL-TIME PROVISIONING VALIDATION FOR TELECOMMUNICATION NETWORKS

(71) Applicant: T-Mobile USA, Inc., Bellevue, WA (US)

(72) Inventors: Henry P. Cyril, Bothell, WA (US); Shrustishree Sumanth, Bellevue, WA (US)

(21) Appl. No.: 18/830,473

(22) Filed: Sep. 10, 2024

(51) Int. Cl. H04L 67/306; H04L 67/303; H04L 67/50

(52) U.S. Cl. CPC H04L 67/306; H04L 67/303; H04L 67/535

(57) ABSTRACT

The system receives, at a validation engine, a production log generated in response to a provisioning operation by a network provisioning engine. The production log includes information about an input profile and a network profile. The input profile indicates at least a first customer service requested to be enabled on the telecommunications network. The network profile indicates at least a first network facing service that corresponds to the first customer service from the input profile. The system compares the information about the input profile and the network profile to reference data stored in a profile database. The reference data includes verified one or more input profiles and corresponding verified one or more network profiles. The system validates the provisioning operation based on whether a match exists between the information in the production log and the reference data. The system generates a report indicating a result of the validating.

### BACKGROUND

In telecommunication, provisioning involves the process of preparing and equipping a network to allow it to provide new services to its users. In national security/emergency preparedness telecommunications services, “provisioning” also refers to “initiation” and includes altering the state of an existing priority service or capability.

The concept of network provisioning or service mediation, mostly used in the telecommunication industry, refers to the provisioning of the customer's services to the network elements, which are various equipment connected in that network communication system. Generally, in telephony provisioning, this is accomplished with network management database table mappings. It requires the existence of networking equipment and depends on network planning and design.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a flowchart illustrating an overview of a current network provisioning procedure of a telecommunications network.

FIG. 4 is a flowchart illustrating the process of building an input profile using a profile builder tool.

FIG. 5 illustrates an example of profile input data used by a real-time validation engine.

FIG. 6 is a flow diagram that illustrates an embodiment of the system with a real-time validation engine using a profile database.

FIG. 7 is a block diagram illustrating an embodiment of the architecture of the provisioning system.

FIG. 8 is a block diagram illustrating an example Machine Learning system.

FIG. 9 is a flow diagram illustrating an embodiment of the system.

FIG. 10 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to a real-time provisioning validation system for validating the provisioning status of subscribers on a telecommunications network. A network provisioning engine (NPE) enables the provisioning or enabling of customer services in the telecommunications network. In some telecommunication networks, the NPE receives provisioning transactions from a billing system that is responsible for determining which input profile, which includes a list of customer services (e.g., data, voice, texts), the NPE will provision for a given third party. For example, a third party can be a partner wholesaler that purchases telecommunications services and resells the telecommunication services to a series of customers. The NPE translates each of the lists of customer services to a network facing service (NFS) using a network profile that corresponds to the determined input profile. The network profile includes a list of NFSs that correspond to the customer services from the input profile. The NFSs are provisioned into various network elements in the telecommunication network for service enablement. In some implementations, the telecommunication network maintains, using input profiles and corresponding network profiles, a mapping between a combination of NFSs and a corresponding combination of customer services (e.g., in the format of a network provisioning catalog). Frequent changes in the network provisioning catalog can create discrepancies between the customer services in an input profile and the corresponding NFSs in a network profile during the provisioning process, causing customers to not receive service(s) they paid for. Currently, to prevent such issues, each change to the mapping or to the network provisioning catalog needs to be manually validated. When manual validation is not feasible due to the multitude and frequency of changes, an increase in discrepancies and loss of services for customers occur due to the modified input profile and corresponding network profile being used before validation has occurred.

The disclosed technology can be implemented in various embodiments to enable real-time validation of the provisioning flow. In some embodiments, a profile database stores reference data for different third parties. The reference data includes different verified input profiles containing possible combinations of customer services for a third party and verified network profiles corresponding to the verified input profiles that contain possible combinations of NFSs for a third party. The reference data is transferred to a real-time validation engine. The real-time validation engine validates the mapping between each combination of NFSs and the corresponding combination of customer services used to provision the various network elements responsible for enabling a service for a customer. The real-time validation engine compares the reference data for the third party to existing data generated by the NPE (e.g., log data corresponding to services). When the comparison indicates a match between the reference data and generated data, the provisioning process proceeds, and the customer is able to access the customer service(s) that he or she subscribed to. When the comparison indicates that there is no match, the system attempts to search the reference data from a different third party that matches the log data. If a match is found, the provisioning process proceeds. If a match is not found, a report is generated to indicate the list of input customer service combinations from the input profile and the corresponding network profile that needs to be manually updated and validated. The system allows every profile to be validated, reduces the number of profiles that need to be manually validated, and reduces the number of customers who experience a loss of service.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

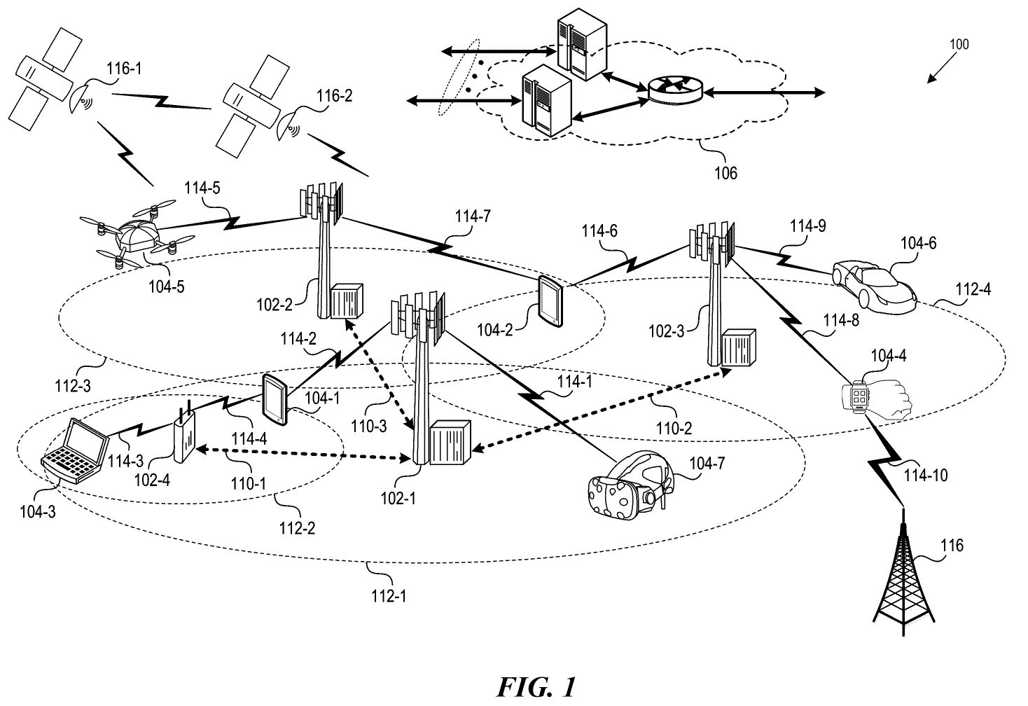

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 1002.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-10 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

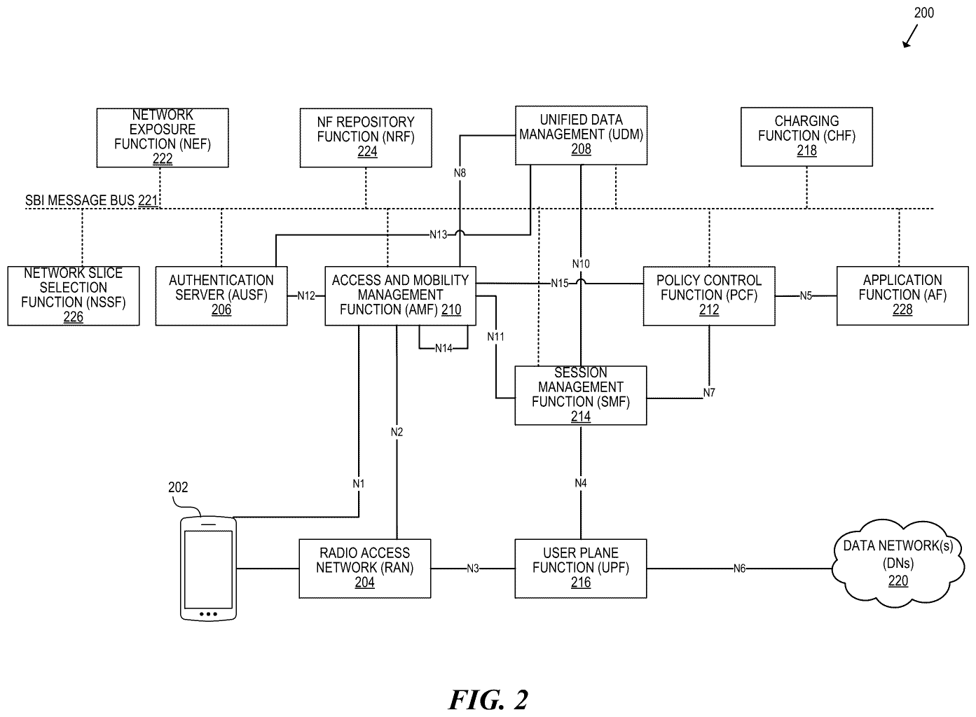

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (Afs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Network Provisioning Real-Time Validation

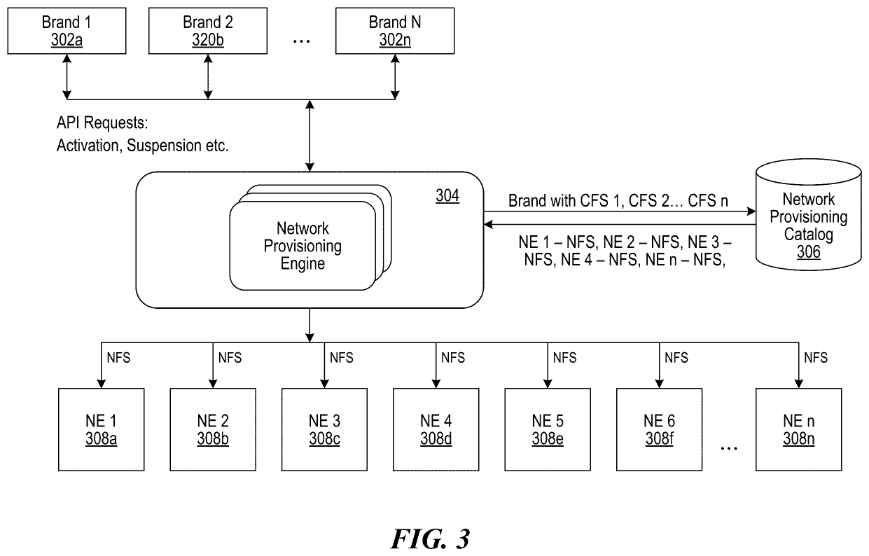

FIG. 3 is a flowchart illustrating an overview of a current network provisioning procedure of a telecommunications network. A telecommunications network operator has many partners. For example, the network operator can sell telecommunications services to third parties, who then resell the telecommunications services to a series of customers. In FIG. 3, Brand 1 302a, Brand 2 302b, . . . , and Brand N 302n are third-party partners with the telecommunications network operator. Each partner may be located in a different region, and each brand can request different combinations of customer services that are used to provide different telecommunications service(s) to a customer. The billing system indicates the combination of customer services that are provisioned for each brand, which is then sent to the network provisioning engine (NPE) 304. The NPE 304 retrieves the combination of NFSs that corresponds to each brand's combination of customer services from the network provisioning catalog 306. The network provisioning catalog 306 stores the mapping between each combination of NFSs and the corresponding combination of customer services for each brand. Each mapping and combination stored at the network provisioning catalog 306 is unique to a given brand. The network provisioning catalog also stores the mapping required to provision the various network elements that are required to enable the services for a customer. For example, each NFS can have a specific network element provisioned to provide a customer service to a customer. Network elements can include, for example, Home Location Register/Home Subscriber Server, Charging System, Policy Enforcement Server (NAP), Short Message Service Server (SMS), Voice Mail Server (VMS), IP Management System (IPM), Caller Tunes, XML Document Management Server, Web Services Gateway, Over the Air System, etc.

When the mapping between the combination of NFSs and the corresponding combination of customer services is determined, the NPE 304 provisions the required network elements. For example, the NPE 304 can provision network elements NE 1 308a and NE 2 308b for voice services, texting, and calling for Brand 1 302a, NE 3 308c, NE 4 308d, and NE 5 308e for calling, texting, data, Wi-Fi calling, and scam protection for Brand 2 320b, and NE 6 308f to NE n 308n for calling, hotspot, and companion device pairing. Because each combination of client services is connected to a specific brand, a discrepancy occurs when the billing system sends a combination of customer services for a specific brand that does not have a corresponding combination of NFSs stored in the network provisioning catalog 306 for that brand. The discrepancy means that the NPE 304 cannot properly provision each network element 308, which causes a customer to not receive the service(s) the customer paid for. A discrepancy is typically only detected when the affected customer contacts customer support about the issue. Discrepancies can occur frequently when partners continually change their combination of customer services. Before the billing system sends the combination of client services to the NPE 304, each change needs to be manually tested so that the new combination of client services can be added to the network provisioning catalog 306. The multitude of changes makes manual testing and validating each change not feasible, leading to an increase in discrepancies and the loss of services for customers.

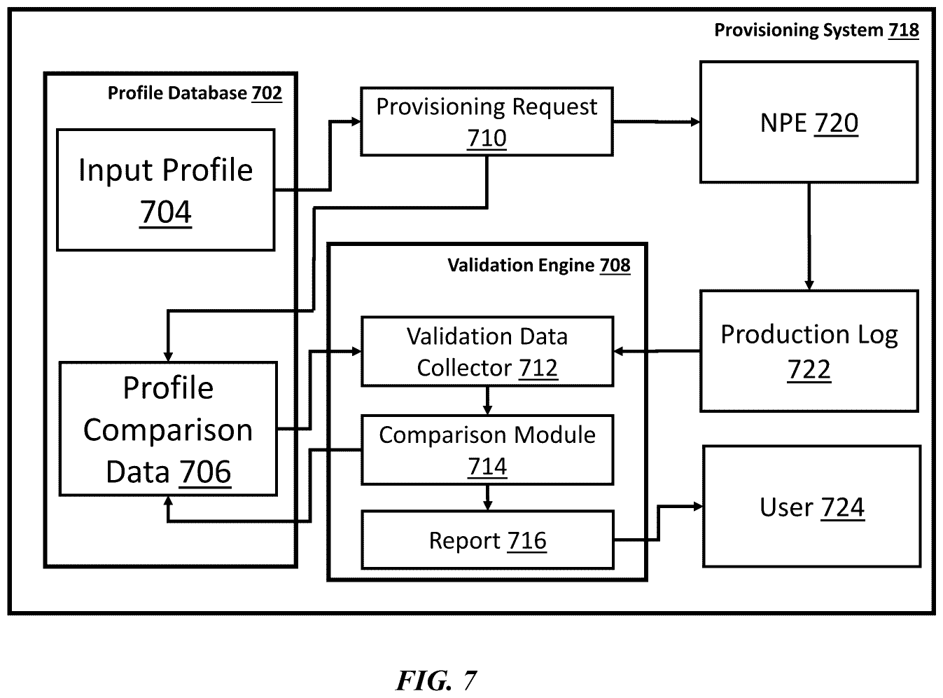

FIG. 7 is a block diagram illustrating an embodiment of the architecture of the provisioning system 718. A provisioning request 710 retrieves an input profile 704 from the profile database 702. The input profile 704 includes the expected combination of customer services that needs to be enabled on the telecommunications network during the provisioning process. Each input profile 704 is categorized based on the third party to which the input profile belongs. The provisioning request 710 stores the retrieved input profile under profile comparison data 706 in the profile database 702 to be used in the validation process. The provisioning request 710 then sends the input profile to the NPE 720. The input profile includes the customer services the third party wants provisioned. The input profile corresponds to a network profile that includes the corresponding NFSs that are provisioned on a network element in order to enable the requested customer services. The NPE 720 provisions the network element based on the input profile. When the provisioning is complete, the NPE generates a production log 722 that details the NFSs that were provisioned on the network element(s) along with customer services that the NFSs correspond to.

When the provisioning process is complete, the validation engine 708 uses a validation data collector 712 to retrieve the input profile 704 stored in the profile comparison data. The validation data collector 712 also retrieves the corresponding production log 722. The validation data collector 712 sends the production log 722, network profile, and the input profile 704 to the comparison module 714. The comparison module 714 first compares the input profile against reference data, which in some embodiments uniquely corresponds to a third party. The reference data includes one or more verified input profiles and the corresponding network profiles for a given third party. For example, the reference data acts as the reference for which combinations of customer services a third party is expected to receive. When a match of the input profile 704 to the reference data is found (e.g., a third party is identified), the comparison module 714 searches the reference data and then compares the data in the production log 722 against the reference behavior indicated by the reference data.

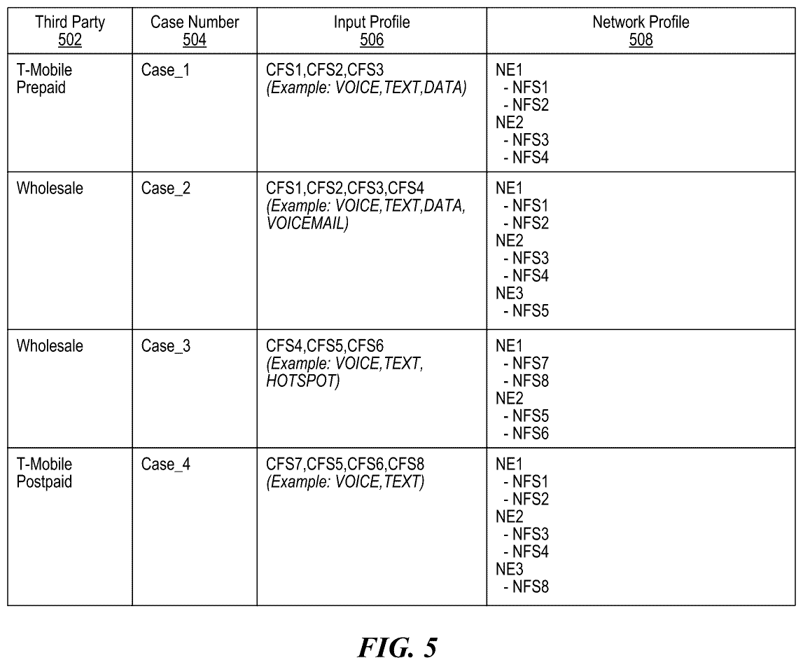

In some embodiments, the production log 722 is parsed and converted to the same format as the network profiles (e.g., as shown in FIG. 5). The comparison module 714 compares the combination of customer services and the corresponding combination of NFSs determined based on the production log 722 against the reference data that includes different combinations of customer service and corresponding combinations of NFSs of third parties whose input profile 704 was used in the provisioning process. When a match is found, the validation engine 708 generates report 716 to notify a user 724 that the provisioning process was successful. When a match is not found, the comparison module searches other reference data for different third parties to determine whether a possible match exists. When a match is found, report 716 indicates a successful provisioning process and optionally indicates that the reference profile may need some updating to correspond to the proper third party. When a match is not found, report 716 indicates an unsuccessful provisioning process. An unsuccessful provisioning process occurs when the provisioning request 710 attempts to retrieve an input profile 704 and/or corresponding network profile that is not included in the profile database 702. For an unsuccessful provisioning process, report 716 includes the input profile and network profile that were unsuccessfully provisioned so that user 724 can add the missing input profile to the profile database 702.

In some embodiments, instead of explicitly parsing and converting the production log 722, the comparison module can include one or more machine learning (ML) models that are trained to recognize customer service information included in the production log. The ML model is capable of classifying the data included in the production log 722. In some embodiments, the ML model is trained on sample production log data to determine which section(s) of the production log correspond to a customer service (e.g., in an input profile) and which section(s) correspond to an NFS (e.g., in a network profile). The ML model classifies each section of the production log as either part of input profile(s), network profile(s), or third-party name(s). The ML uses this classification to compare the production log against the reference data contained in the profile database to validate the provisioning process.

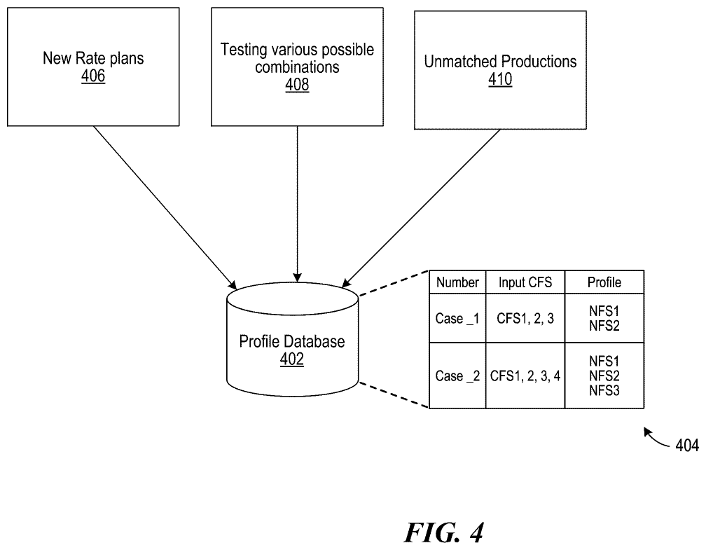

FIG. 4 is a flowchart illustrating the process of adding profiles 404 to the profile database 402. Each profile 404 includes an input profile and a network profile. The input profile includes a combination of customer services that a third party could request to have enabled on the telecommunications network. The network profile includes the combination of NFSs that correspond to the combination of customer services in the input profile. The profiles 404 can be used by the NPE during the provisioning process and/or be added to the reference data to be used during the validation process. The profiles 404 are categorized based on which third party the profile 404 belongs to. Each profile 404 includes a label to identify the specific combination of customer services contained in the profile, the specific combination of customer profiles, and the corresponding combination of NFSs. Each profile 404 is stored in the profile database 402. The data used to generate each profile 404 can originate from a different source or for a different reason. For example, the profile 404 can be generated when a new rate plan 406 is created (e.g., when a third party requests a new combination of customer services to be provisioned for their customers). A profile 404 can also be generated by testing various possible combinations 408. Testing various possible combinations 408 is the process of generating expected or possible combinations of customer services and the corresponding combinations of NFSs. A profile 404 can also be generated by unmatched productions 410. An unmatched production occurs when the NPE attempts to provision a certain combination of customer services that does not have a corresponding profile 404 stored in the profile database 402. When an unmatched production 410 occurs, a user generates the missing profile 404 so the profile 404 can be added to the profile database 402.

FIG. 5 illustrates an example of the reference data used by a real-time validation engine. The reference data includes the third party 502, which indicates the third party that the reference data corresponds to. For example, the third party 502 can indicate that the third party is an outside wholesaler or subsidiary, such as T-Mobile Prepaid. The reference data includes the case number 504. The case number 504 can be used to identify the input profile 506 and network profile 508 for each third party. The case number 504 can be labeled as “Case_2” to indicate that the reference data corresponds to a wholesaler and a first input profile for that wholesaler. “Case_3” can indicate that the reference data corresponds to the same wholesaler as “Case_2” but to a second combination input profile for that wholesaler.

The input profile 506 indicates the combination of customer services that needs to be enabled by the NPE during the provisioning process. For example, a combination of input customer services can be referred to as Customer Facing Services (CFSs): CFS1, CFS2, and CFS3. For example, the CFSs can correspond to voice, text, and data, respectively. The combination can also be CFS1, CFS2, CFS3, and CFS4, which corresponds to voice, text, data, and voicemail, or CSF2, CSF3, and CFS5, which corresponds to text, data, and hotspot. The network profile 508 indicates the corresponding NFSs that are provisioned on the network node to provide each customer service. For example, NE1 with NFSs 1 and 2 and NE2 with NFSs 3 and 4 can be provisioned when the customer services are voice, text, and data. NE1 with NFSs 1 and 2, NE2 with NFSs 3 and 4, and NE3 with NFS 5 can be provisioned when the customer services are voice, text, data, and voicemail. NE1 with NFSs 7 and 8 and NE2 with NFSs 5 and 6 can be provisioned when the customer services are voice, text, and hotspot.

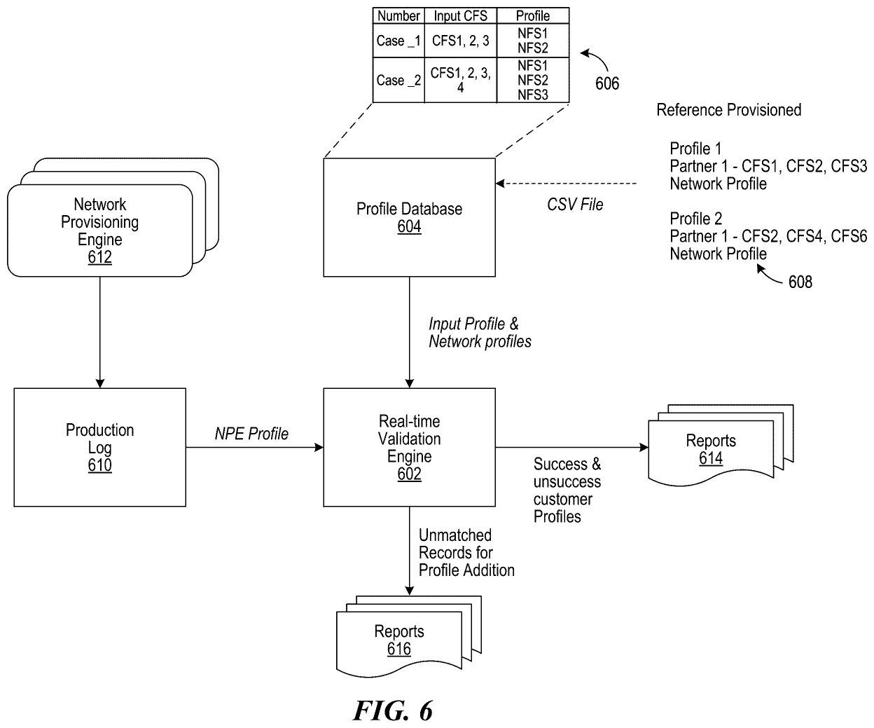

FIG. 6 is a flow diagram that illustrates an embodiment of the system with a real-time validation engine 602 using a profile database 604. The real-time validation engine 602 validates the data in the production logs 610 generated by the network provisioning engine 612. Every time the network provisioning engine 612 provisions a network element to enable a customer service, a production log 610 is generated. The production log 610 contains the input profiles and the network profiles used to enable the customer service(s). However, in some embodiments, the production log 610 may be in a specific format that needs to be processed to obtain information about input profiles and network profiles. An example of production log 610 is shown below.

““<![CDATA[<TriggerPoint><ConditionTypeCNF>1</ConditionTypeCNF><SPT><Conditi
onNegated>0</ConditionNegated><Group>0</Group><Method>REGISTER</Method><
Extension><RegistrationType>0</RegistrationType></Extension></SPT><SPT><Condit
ionNegated>0</ConditionNegated><Group>0</Group><Method>REGISTER</Method>
<Extension><RegistrationType>1</RegistrationType></Extension></SPT><SPT><Cond
itionNegated>0</ConditionNegated><Group>0</Group><Method>REGISTER</Method
><Extension><RegistrationType>2</RegistrationType></Extension></SPT><SPT><Con
ditionNegated>0</ConditionNegated><Group>1</Group><SIPHeader><Header>Contac
t</Header><Content>.*g.3gpp.smsip.*</Content></SIPHeader></SPT><SPT><Group>1
</Group><SIPHeader><Header>Contact</Header><Content>.*expires=0.*</Content></
SIPHeader></SPT></TriggerPoint>]]>””

The real-time validation engine 602 analyzes the production log 610 to determine the input profile and the corresponding network profile used to provision a network element and enable the customer service(s). In some embodiments, the real-time validation engine 602 parses the production log 610 and converts the relevant information into the format of an input profile and network profile.

The real-time validation engine 602 retrieves, from the profile database 604, the reference data 606 corresponding to the data in the received production log 610. The reference data 606 can be generated using the reference provisioned data 608. In some embodiments, the real-time validation engine 602 performs a comparison of the production log 610 against reference data 606 in the profile database 604 until a match is found. To accomplish this, the real-time validation engine 602 first compares the third party associated with the production log 610 against each third party that has reference data 606 in the profile database 604. The real-time validation engine 602 then compares the input profile and network profile contained in the production log 610 to the reference data of the third party. The reference data includes verified input profiles and corresponding network profiles associated with the third party. For example, the real-time validation engine compares the input profile of the production log 610 against multiple verified input profiles from the reference data 606 until a match is found. This same process also occurs with the network profile from the production log until a match is found. When a match is not found, the real-time validation engine compares the input profile and network profile from the production log 610 to reference data 606 of different third parties. The real-time validation engine 602 can limit the search to the reference data 606 that match the third party in the production log 610 to increase the speed of the validation and reduce the amount of energy and processing power used.

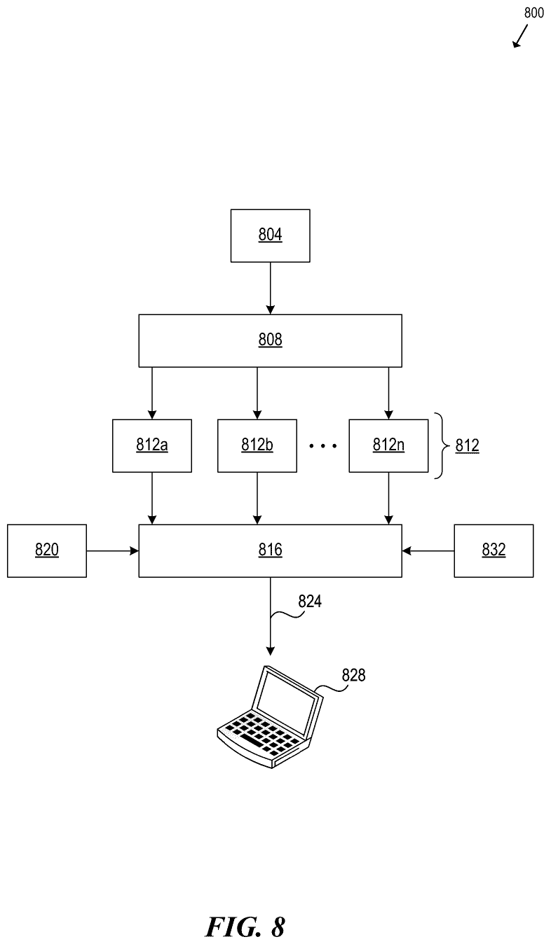

In some other embodiments, the real-time validation engine 602 uses an ML model to compare the data of the production log against the reference data 606 in the profile database 604. The real-time validation engine 602 uses the ML model to analyze the production log. The ML model is trained to recognize the different customer services from the input profile and the corresponding NFSs from the network profile along with the third party that the production log 610 is associated with. In some embodiment, the ML model is trained using similarity measurement techniques based on the K-Nearest Neighbors (KNN) algorithm. Techniques such as isolation forest and Support Vector Machine (SVM), which are described in further detail in connection with FIG. 8, can be used to identify a deviation or mismatch in the data of the production logs and reference data. The KNN algorithm identifies a degree of the match between the data of the production logs and reference data. Anomaly detection can be performed using the isolation forest or one-class SVM to identify the deviations or outliers. Isolation forest is an algorithm that algorithm isolates observations by randomly selecting features and splitting values, effectively detecting anomalies in high-dimensional data. One-class SVM models the normal data distribution and identifies data points that deviate significantly from this distribution as anomalies. Combining isolation forest and one-class SVM allows the ML model to effectively compare data and detect matches and anomalies, ensuring robust validation and accurate identification of data discrepancies.

Once trained The ML model compares the recognized input profile and network profile against the reference data 606 of the third party until a match is found. When a match is not found, the ML model compares the recognized input profile and network profile against reference data for different third parties until a match is found. This process allows the real-time validation engine to validate the provisioning process without needing to convert the production logs to a format identical to the reference data.

A match is found when a verified input profile and network profile from the reference data 606 are identical to the input profile and network profile contained in the production log 610. When a match is found, the real-time validation engine 602 generates a first report 614 indicating that the customer services were properly enabled on the telecommunications network. When a match is not found, an unsuccessful customer profile occurs, which can also be included in the first report 614. An unmatched profile indicates to the real-time validation engine 602 that the customer services were not properly provisioned and the customer is not receiving the service(s) they paid for. The real-time validation engine 602 generates a second report 616. The second report 616 indicates to a user the third party, the input profile, and the corresponding network profile that did not have matching reference data 606 and was incorrectly provisioned. The user can then manually enter the mapping between the input profile and the corresponding network profile for that combination into the profile database 604 as reference provisioned data 608. This process allows the user to receive real-time reports, which allows the user to fix a provisioning issue before a customer reports the issue.

### Machine Learning Model

FIG. 8 is a block diagram illustrating an example ML system 800, in accordance with one or more embodiments. Likewise, different embodiments of the ML system 800 include different and/or additional components and are connected in different ways. The ML system 800 is sometimes referred to as an ML module.

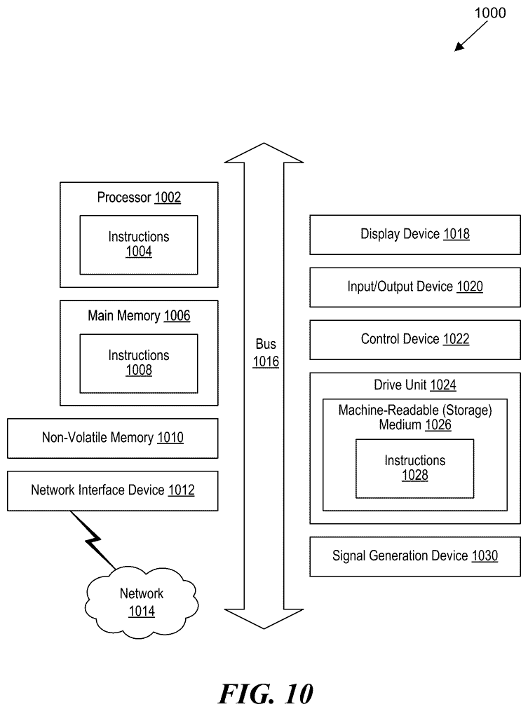

The ML system 800 includes a feature extraction module 808 implemented using components of the example computer system 1000 illustrated and described in more detail with reference to FIG. 10. In some embodiments, the feature extraction module 808 extracts a feature vector 812 from input data 804. The feature vector 812 includes features 812a, 812b, . . . , 812n. The feature extraction module 808 reduces the redundancy in the input data 804, for example, repetitive data values, to transform the input data 804 into the reduced set of features 812, for example, features 812a, 812b, . . . , 812n. The feature vector 812 contains the relevant information from the input data 804 such that events or data value thresholds of interest are identified by the ML model 816 by using a reduced representation. In some example embodiments, the following dimensionality reduction techniques are used by the feature extraction module 808: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In alternate embodiments, the ML model 816 performs deep learning (also known as deep structured learning or hierarchical learning) directly on the input data 804 to learn data representations, as opposed to using task-specific algorithms. In deep learning, no explicit feature extraction is performed; the features 812 are implicitly extracted by the ML system 800. For example, the ML model 816 uses a cascade of multiple layers of nonlinear processing units for implicit feature extraction and transformation. Each successive layer uses the output from the previous layer as input. The ML model 816 thus learns in supervised (e.g., classification) and/or unsupervised (e.g., pattern analysis) modes. The ML model 816 learns multiple levels of representations that correspond to different levels of abstraction, wherein the different levels form a hierarchy of concepts. The multiple levels of representation configure the ML model 816 to differentiate features of interest from background features.

In alternative example embodiments, the ML model 816, for example, in the form of a convolutional neural network (CNN), generates the output 824, without the need for feature extraction, directly from the input data 804. The output 824 is provided to the computer device 828. The computer device 828 is a server, computer, tablet, smartphone, smart speaker, etc., implemented using components of the example computer system 1000 illustrated and described in more detail with reference to FIG. 10. In some embodiments, the steps performed by the ML system 800 are stored in memory on the computer device 828 for execution. In other embodiments, the output 824 is displayed on an electronic display of the computer device 828.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In some embodiments, the ML model 816 is a CNN that includes both convolutional layers and max pooling layers. For example, the architecture of the ML model 816 is “fully convolutional,” which means that variable-sized sensor data vectors are fed into it. For convolutional layers, the ML model 816 specifies a kernel size, a stride of the convolution, and an amount of zero padding applied to the input of that layer. For the pooling layers, the ML model 816 specifies the kernel size and stride of the pooling.

In some embodiments, the ML system 800 trains the ML model 816, based on the training data 820, to correlate the feature vector 812 to expected outputs in the training data 820. As part of the training of the ML model 816, the ML system 800 forms a training set of features and training labels by identifying a positive training set of features that have been determined to have a desired property in question and, in some embodiments, forms a negative training set of features that lack the property in question. The training data 820 can include verified input profiles and the corresponding verified network profiles.

The ML system 800 applies ML techniques to train the ML model 816 that, when applied to the feature vector 812, outputs indications of whether the feature vector 812 has an associated desired property or properties, such as a probability that the feature vector 812 has a particular Boolean property, or an estimated value of a scalar property. In some embodiments, the ML system 800 further applies dimensionality reduction (e.g., via linear discriminant analysis (LDA), PCA, or the like) to reduce the amount of data in the feature vector 812 to a smaller, more representative set of data.

In some embodiments, the ML system 800 uses supervised ML to train the ML model 816, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 832 is formed of additional features, other than those in the training data 820, which have already been determined to have or to lack the property in question. The ML system 800 applies the trained ML model 816 to the features of the validation set 832 to quantify the accuracy of the ML model 816. Common metrics applied in accuracy measurement include Precision and Recall, where Precision refers to a number of results the ML model 816 correctly predicted out of the total it predicted, and Recall is a number of results the ML model 816 correctly predicted out of the total number of features that had the desired property in question. In some embodiments, the ML system 800 iteratively retrains the ML model 816 until the occurrence of a stopping condition, such as the accuracy measurement indication that the ML model 816 is sufficiently accurate, or a number of training rounds having taken place. In embodiments, the validation set 832 includes data corresponding to confirmed locations, dates, times, activities, or combinations thereof. This allows the detected values to be validated using the validation set 832. The validation set 832 is generated based on the analysis to be performed.

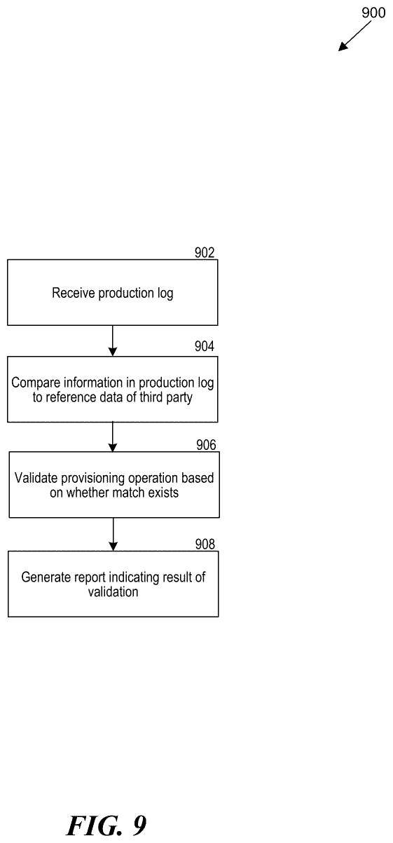

FIG. 9 is a flowchart that illustrates an embodiment of process 900 of the system. In one example, the system includes at least one hardware processor and at least one non-transitory, memory-storing instruction, which, when executed by at least one hardware processor, causes the system to perform process 900.

At step 902, the system receives, at a validation engine, a production log generated in response to a provisioning operation by a network provisioning engine for a third party. The production log includes information about an input profile and a network profile. The input profile indicates at least a first customer service requested to be enabled on the telecommunications network and the network profile indicates at least a first network facing service (NFS) that corresponds to the first customer service from the input profile that is provisioned on a network element. At step 904, the system compares, based on the production log for the third party, the information about the input profile and the network profile to reference data of the third party stored in a profile database. The reference data of the third party includes verified one or more input profiles and corresponding verified one or more network profiles.

At step 906, the system validates the provisioning operation based on whether a match exists between the information about the input profile and the network profile and the reference data. The match exists when the first customer service from the input profile is identical to a verified customer service from the verified one or more input profiles from the reference data and when the first NFS from the network profile is identical to a corresponding verified NFS from the verified one or more network profiles of the reference data. In some examples, the real-time validation engine can use one or more ML models to validate the input profile and corresponding network profile from the production log against the reference data.

At step 908, the system generates a report that indicates a result of the validating. In some examples, the system can send a user the report to notify the user of each successful and unsuccessful provisioning. In some other examples, the system can generate, upon determining that the match does not exist, a second report indicating to a user to add the at least one customer service and the corresponding at least one NFS from the production log to the profile database for the third party.

In some examples, before the first report is generated, the system can compare the production log to reference data of a different third party. The system can validate the provisioning based on whether the input profile and network profile from the production log matches a verified input profile and network profile from the reference data of the different third party. The match exists when the at least first customer service from the input profile is identical to the verified customer service from the verified one or more input profiles from the reference data and when the at least first NFS from the network profile is identical to the corresponding verified NFS from the verified network profile of the reference data. In some other examples, the system can generate, upon determining that the match does not exist in the reference data of the different third party, a second report indicating that the information about the input profile and the corresponding network profile in the production log is missing from the reference data of the third party. In some other examples, a user can update the reference data of the third party based on the second report.

In some other embodiments, the system is in a telecommunications network and comprises a profile database configured to store reference data for multiple third parties. The reference data includes a verified one or more input profiles and corresponding verified one or more network profiles for each third party. Each verified one or more input profiles includes a verified customer service enabled on the telecommunications network. Each verified one or more network profiles includes a verified NFS that is used to provision a network element and enable the verified customer service. In some examples, the system can further include a billing system configured to indicate, to the provisioning request, the input profile to be requested. In some other examples, the system can further include a provisioning request including a request for the input profile to be enabled on the telecommunications network. The provisioning request retrieves, for the NPE, the input profile from a network provisioning catalog stored on the profile database.

The system further comprises an NPE coupled to the profile database and configured to enable at least a first customer service on the telecommunications network by provisioning the network element using an input profile that includes information about the at least first customer service to be enabled on the telecommunications network. The NPE is configured to provision the network element based on a corresponding network profile. In some examples, the network profile includes a mapping between the at least first customer service in the input profile and a corresponding at least first NFS in the network profile.

The system further comprises a validation engine, coupled to the profile database and NPE, configured to validate the provisioning performed by the NPE. The validation engine receives a production log from the NPE that includes information about the input profile and the corresponding network profile used to provision the at least one network element. The validation engine compares the information about the input profile and the network profile determined from the production log against the reference data of the third party stored in the profile database. The validation engine generates a report to indicate the result of the comparison. In some examples, the validation engine can further include a second report that indicates an unsuccessful provisioning by the NPE. The second report indicates a need to add the input profile and corresponding network profile used by the NPE to the reference data of the third party. In some other examples, a different production log is generated for each input profile that is enabled on the telecommunications network. In some other examples, the system can further include one or more ML models configured to compare the information about the input profile and corresponding network profile from the production log to the reference data.

### Computer System

FIG. 10 is a block diagram that illustrates an example of a computer system 1000 in which at least some operations described herein can be implemented. As shown, the computer system 1000 can include: one or more processors 1002, main memory 1006, non-volatile memory 1010, a network interface device 1012, a video display device 1018, an input/output device 1020, a control device 1022 (e.g., keyboard and pointing device), a drive unit 1024 that includes a machine-readable (storage) medium 1026, and a signal generation device 1030 that are communicatively connected to a bus 1016. The bus 1016 represents one or more physical buses and/or point-to-point connections that are connected by appropriate bridges, adapters, or controllers. Various common components (e.g., cache memory) are omitted from FIG. 10 for brevity. Instead, the computer system 1000 is intended to illustrate a hardware device on which components illustrated or described relative to the examples of the figures and any other components described in this specification can be implemented.

The computer system 1000 can take any suitable physical form. For example, the computing system 1000 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1000. In some implementations, the computer system 1000 can be an embedded computer system, a system-on-chip (SOC), a single-board computer system (SBC), or a distributed system such as a mesh of computer systems, or it can include one or more cloud components in one or more networks. Where appropriate, one or more computer systems 1000 can perform operations in real time, in near real time, or in batch mode.

The network interface device 1012 enables the computing system 1000 to mediate data in a network 1014 with an entity that is external to the computing system 1000 through any communication protocol supported by the computing system 1000 and the external entity. Examples of the network interface device 1012 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1006, non-volatile memory 1010, machine-readable medium 1026) can be local, remote, or distributed. Although shown as a single medium, the machine-readable medium 1026 can include multiple media (e.g., a centralized/distributed database and/or associated caches and servers) that store one or more sets of instructions 1028. The machine-readable medium 1026 can include any medium that is capable of storing, encoding, or carrying a set of instructions for execution by the computing system 1000. The machine-readable medium 1026 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1010, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in computing device(s). When read and executed by the processor 1002, the instruction(s) cause the computing system 1000 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A computer-implemented method for validating provisioning on a telecommunications network, comprising:
receiving, at a validation engine, a production log generated in response to a provisioning operation by a network provisioning engine for a third party,
wherein the production log includes information about an input profile and a network profile,
wherein the input profile indicates at least a first customer service requested to be enabled on the telecommunications network, and
wherein the network profile indicates at least a first network facing service (NFS) that corresponds to the first customer service from the input profile that is provisioned on a network element;
comparing, based on the production log for the third party, the information about the input profile and the network profile to reference data of the third party stored in a profile database,
wherein the reference data of the third party includes verified one or more input profiles and corresponding verified one or more network profiles;
validating the provisioning operation based on whether a match exists between the information about the input profile and the network profile and the reference data,
wherein the match exists when the first customer service from the input profile is identical to a verified customer service from the verified one or more input profiles from the reference data and when the first NFS from the network profile is identical to a corresponding verified NFS from the verified one or more network profiles of the reference data; and
generating a report that indicates a result of the validating.

2. The computer-implemented method of claim 1, further comprising:
generating, upon determining that the match does not exist, a second report indicating to a user to add the first customer service and the first NFS from the production log to the profile database for the third party.

3. The computer-implemented method of claim 1, further comprising:
comparing the production log to reference data of a different third party; and
validating the provisioning based on whether the input profile and network profile from the production log matches a verified input profile and network profile from the reference data of the different third party,
wherein the match exists when the first customer service from the input profile is identical to the verified customer service from the verified one or more input profiles from the reference data and when the first NFS from the network profile is identical to the corresponding verified NFS from the verified network profile of the reference data.

4. The computer-implemented method of claim 3, further comprising:
generating, upon determining that the match does not exist in the reference data of the different third party, a second report indicating that the information about the input profile and the corresponding network profile in the production log is missing from the reference data of the third party.

5. The computer-implemented method of claim 4, wherein a user updates the reference data of the third party based on the second report.

6. The computer-implemented method of claim 1, wherein the validation engine is configured to use one or more machine learning models to validate the input profile and corresponding network profile from the production log against the reference data.

7. The computer-implemented method of claim 1, further comprising:
sending the report to notify a user of a successful or unsuccessful provisioning.

8. A system in a telecommunications network, comprising:
a profile database configured to store reference data for multiple third parties,
wherein the reference data includes a verified one or more input profiles and corresponding verified one or more network profiles for a third party,
wherein each verified one or more input profiles includes a verified customer service enabled on the telecommunications network, and
wherein each verified one or more network profiles includes a verified network facing service (NFS) that is used to provision a network element and enable the verified customer service;
a network provisioning engine (NPE) coupled to the profile database and configured to enable at least a first customer service on the telecommunications network by provisioning the network element using an input profile that includes information about the first customer service to be enabled on the telecommunications network,
wherein the NPE is configured to provision the network element based on a corresponding network profile; and
a validation engine, coupled to the profile database and NPE, configured to validate the provisioning performed by the NPE,
wherein the validation engine receives a production log from the NPE that includes information about the input profile and the corresponding network profile used to provision the network element,
wherein the validation engine performs a comparison of the information about the input profile and the corresponding network profile determined from the production log against the reference data of the third party stored in the profile database, and
wherein the validation engine generates a report to indicate a result of the comparison.

9. The system of claim 8, further comprising:
a provisioning request including a request for the input profile to be enabled on the telecommunications network,
wherein the provisioning request retrieves, for the NPE, the input profile from a network provisioning catalog stored on the profile database.

10. The system of claim 9, further comprising:
a billing system configured to indicate, to the provisioning request, the input profile to be requested.

11. The system of claim 8, wherein the validation engine further comprises:
a second report that indicates an unsuccessful provisioning by the NPE,
wherein the second report indicates a need to add the input profile and the corresponding network profile used by the NPE to the reference data of the third party.

12. The system of claim 8, wherein a different production log is generated for each input profile that is enabled on the telecommunications network.

13. The system of claim 8, further including:
one or more machine learning models configured to compare the information about the input profile and corresponding network profile from the production log to the reference data.

14. The system of claim 8, wherein the corresponding network profile includes a mapping between the first customer service in the input profile and a corresponding at least first NFS in the corresponding network profile.

15. A non-transitory, computer-readable storage medium comprising instructions recorded thereon, wherein the instructions, when executed by at least one data processor of a system, cause the system to:
receive, at a validation engine, a production log generated in response to a provisioning operation by a network provisioning engine for a third party,
wherein the production log includes information about an input profile and a network profile,
wherein the input profile indicates at least a first customer service requested to be enabled on a telecommunications network, and
wherein the network profile indicates at least a first network facing service (NFS) that corresponds to the first customer service from the input profile that is provisioned on a network element;
compare, based on the production log for the third party, the information about the input profile and the network profile to reference data of the third party stored in a profile database,
wherein the reference data of the third party includes verified one or more input profiles and corresponding verified one or more network profiles;
perform a validation of the provisioning operation based on whether a match exists between the information about the input profile and the network profile and the reference data; and
generate a report that indicates a result of the validation.

16. The non-transitory, computer-readable storage medium of claim 15, wherein the instructions further cause the system to:
generate, upon determining that the match does not exist, a second report indicating to a user to add the first customer service and the corresponding NFS from the production log to the profile database for the third party.

17. The non-transitory, computer-readable storage medium of claim 15, wherein the instructions further cause the system to:
compare the production log to reference data of a different third party; and
validate the provisioning based on whether the input profile and network profile from the production log matches a verified input profile and network profile from the reference data of the different third party.

18. The non-transitory, computer-readable storage medium of claim 17, wherein the instructions further cause the system to:
generate, upon determining that the match does not exist in the reference data of the different third party, a second report indicating that the information about the input profile and the corresponding network profile in the production log is missing from the reference data of the third party.

19. The non-transitory, computer-readable storage medium of claim 15, wherein the validation engine is configured to use one or more machine learning models to validate the input profile and the corresponding network profile from the production log against the reference data.

20. The non-transitory, computer-readable storage medium of claim 15, wherein the instructions further cause the system to:
send a user the report to notify the user of each successful and unsuccessful provisioning.
